(19) United States
(12) Patent Application Publication
(10) Pub. No.: US 2007/0121689 A1
(43) Pub. Date: May 31, 2007

(54) Methods for Producing Diode-Pumped Micro Lasers

(75) Inventor: David C. Brown, Brackney, PA (US)

Correspondence Address: BROWN & MICHAELS, PC;400 M & T BANK BUILDING, 118 NORTH TIOGA ST, ITHACA, NY, 14850, US

(73) Assignee: SNAKE CREEK LASERS LLC, Hallstead, PA (US)

(21) Appl. No.: 11/624,797

(22) Filed: Jan. 19, 2007

Related U.S. Application Data
(63) Continuation-in-part of application No. 10/946,941, filed on Sep. 22, 2004.
(60) Provisional application No. 60/504,617, filed on Sep. 22, 2003.

(51) Int. Cl. H01S 3/14

(52) U.S. Cl. 372/39

(57) ABSTRACT

A miniaturized laser package includes a modern LDP, modified to accept a solid state microchip assembly pumped by the diode laser. The microchip assembly is added to standard LDPs containing laser diodes mounted on heatsinking shelves by affixing a second shelf to mount and heatsink the microchip assembly. Standard packages described in the invention include 9 mm and 5.6 mm packages, all of which are characterized by small dimensions, well sealed housing, robust mounting features, known characterized materials, economical production, and assembly techniques characteristic of the semiconductor processing industry.

### REFERENCE TO RELATED APPLICATIONS

This is a continuation in part application of co-pending application Ser. No. 10/946,941, filed Sep. 22, 2004, entitled “HIGH DENSITY METHODS FOR PRODUCING DIODE-PUMPED MICRO LASERS”, which claimed an invention which was disclosed in Provisional Application No. 60/504,617, filed Sep. 22, 2003, entitled “HIGH DENSITY METHODS FOR PRODUCING DIODE-PUMPED MICRO LASERS”. The benefit under 35 USC §119(e) of the United States provisional application is hereby claimed, and the aforementioned applications are hereby incorporated herein by reference.

### BACKGROUND OF THE INVENTION

1. Field of the Invention

The present invention relates to highly compact and/or miniaturized diode pumped solid state lasers that are fabricated using industry standard laser diode packages.

2. Description of Related Art

New types of microlasers are desired as a replacement for conventional red lasers, particularly red semiconductor diode lasers that are commonplace in many applications including pointing devices, supermarket scanners, gun pointers, and others. While diode lasers can provide wavelength coverage in the blue, red, and near infrared regions, currently no diode laser technology can produce green wavelengths with any substantial output power. Yet, the green wavelength region is particularly important because it is the region where the spectral responsivity of the human eye is at a maximum and where underwater transmission peaks. In addition, diode lasers are typically low-brightness devices with an astigmatic output due to the disparity in divergence angles in the directions parallel and perpendicular to the diode stripe. On the other hand, solid state lasers—even compact modern diode-pumped, versions—tend to be too bulky and/or expensive to be used in mass applications such as supermarket scanners or for writing compact disks. Furthermore, solid state lasers tend to emit their fundamental radiation in the infrared region of the spectrum near and around 1 μm, and additional means must therefore be incorporated in the laser to produce light in the visible region. These means generally include one or more nonlinear processes. For example, a second-harmonic-generation (SHG) process can be used to convert the 1064 nm transition in Nd doped YAG (yttrium aluminum garnet) or YVO₄ (vanadate), to an output wavelength at 532 nm, using a suitable nonlinear crystal. More generally, sum frequency-generation (SFG) can be applied to sum the frequencies of two different laser wavelengths. The most common application of SFG is third harmonic generation (THG), where an infrared and a green photon are added to produce UV radiation, for example at 355 nm in the Nd-doped materials mentioned above. Alternatively, different transitions from the same material can be summed to produce still other wavelengths. In addition to SHG and SFG, there are other nonlinear processes that can be used to produce other discrete wavelengths using fixed laser transitions, including optical parametric amplification (OPA), and Raman shifting. Whereas techniques and materials are known that can be used to generate a variety of wavelengths from solid state lasers across the visible spectrum, the nonlinear techniques can greatly expand the range of wavelengths available from a single solid state laser crystal. However, these means all tend to add bulk and cost to the systems, even when simple diode pumped designs are utilized. This is particularly true for green lasers designed to run in a single-transverse (Gaussian) mode (STM) and/or single-longitudinal mode (SLM). There are two generic ways to frequency-double a laser, known as external (extra-cavity) doubling or internal (intra-cavity) doubling. Note that “cavity” and “resonator” are used interchangeably to describe an optical resonator herein. In the extra-cavity doubling case, a beam from a laser source is passed through a nonlinear crystal with some of the beam's energy converted to green output. There are known limitations to any extra-cavity nonlinear process that tend to limit the efficiency of harmonic conversion—especially where high peak powers are not available, as in the case of, e.g., continuous wave (CW) lasers where SHG efficiencies are generally less than 5%. By contrast, considerably higher efficiencies may be obtained for intra-cavity conversion, where the nonlinear crystal is placed internal to the resonator, because the intensity of the fundamental beam inside the resonator is significantly larger than in the extra-cavity case. The intra-cavity frequency doubled configuration is therefore the one most commonly used for lower power and/or CW lasers.

FIG. 1 shows a generic intra-cavity doubling configuration that is directly applicable to gain materials such as Nd:YAG (yttrium aluminum garnet) or Nd:YVO₄ (orthovanadate) which have a fundamental laser transition near 1064 nm and are typically optically pumped by radiation at or near 808 nm. The pump radiation is supplied by a semiconductor laser, which may include, in various embodiments, a direct coupled diode laser, fiber-coupled diode, or a diode array. Alternatively, the Nd laser transition may also be pumped directly at the longer wavelengths of 869 or 885 nm. Laser light generated at the laser wavelength—in this case at 1064 nm—is optically “trapped” inside the resonator when highly reflective coatings are used at each end of the resonator. To allow for more compact cavities, at least one end of the resonator may be defined by the laser gain material itself. In the example of FIG. 1, the laser material facing towards the diode or diode array is coated so it is highly transmissive (HT) at the pump wavelength, and highly reflecting (HR) at the laser wavelength. The lasing crystal's opposite face is typically anti-reflection (AR) coated at the fundamental wavelength of 1064 nm and also at 532 nm if the laser is intra-cavity doubled. In this case, the optical resonator is formed between the rear surface of the lasing crystal (facing the diode) and the outcoupler. The outcoupler, which may in different examples have a curved or a flat surface facing the diode, is typically a partial reflector (PR) if the 1064 nm transition is lased or is coated for HR at 1064 nm and HT at 532 nm if intra-cavity SHG is implemented. The output surface of the outcoupler is usually AR coated at the second harmonic wavelength for intra-cavity doubled laser configuration. For a stable optical resonator, a planar output coupler may be used if the thermal lensing imparted to the lasing material by the absorbed pump radiation is sufficient to assure TEM₀₀ operation. Alternatively, the output surface of the outcoupler can be curved in order to maintain resonator stability. The curvature may be further adapted to diverge or collimate the output laser beam, as needed. In other configurations, the outcoupler may be separate from the laser crystal itself and may or may not have a curved surface. In those configurations, the distal end of the crystal would have an AR coating at the laser fundamental wavelength and at the second harmonic wavelength, and the outcoupler surface facing the diode would be coated HR at the laser fundamental wavelength and HT at the second harmonic wavelength.

Because the outcoupling at 1064 nm in the intra-cavity doubling case is nil, approximately equal intensities of the fundamental radiation circulate inside the resonator, to the right and to the left. This results in the build up of a high 1064 nm CW intensity inside the resonator. Each fundamental beam generates a green beam traveling in the same direction. Since the fundamental beam inside the resonator travels in both the + (right) and − (left) directions, green second-harmonic beams are also generated in both directions. If the outcoupler is coated for HT at the second harmonic wavelength, the green light traveling to the right exits the resonator. Green light traveling to the left is reflected back to the right from the 532 nm HR coated surface on the side of the lasing crystal facing the diode and subsequently also leaves the resonator through the outcoupler, co-linear with the right traveling green beam. In spite of the fact that there is usually some finite absorption at the second harmonic wavelength in the lasing crystal, collecting the backward (left) traveling green light results in a substantial improvement in the green conversion efficiency. If high quality optics and crystals are used, even for CW operation, the intensity generated in the resonator is sufficient to result in 10-35% conversion efficiencies from diode output to green output. Still higher conversion efficiencies can be achieved for pulsed operation, in which case a Q-switch is typically included in the cavity.

It is noted that the basic configuration shown in FIG. 1—whether pulsed or CW—is well known in the art of constructing diode pumped intra-cavity frequency doubled lasers. It is also understood that although the embodiment of FIG. 1 is specific to the main transition of Nd:YAG or Nd:YVO₄ at 1064 nm, similar principles apply to other transitions in these or other laser materials. For example, alternative transitions that can be lased include the ones at the 946 nm or the 1319 nm for Nd:YAG and the corresponding transitions at 914.5 nm and 1342 nm in Nd:YVO₄. Intra-cavity conversion of the ⁴F_{3/2}→⁴I_{9/2} in Nd doped lasers into the blue was taught in the early U.S. Pat. No. 4,809,291 to Byer et al. and a monolithic version of intra-cavity doubled Nd doped vanadate laser was described in U.S. Pat. No. 5,574,740 to Hargis and Nelte. Other Nd-doped materials, such as Nd:YLF or Nd:YALO can also be employed in an intra-cavity configuration similar to FIG. 1 with laser action selected at the fundamental or at an alternate transition. One important modification to the cavity of FIG. 1, when selecting an alternate lower gain transition, is that the corresponding HR coatings on the various surfaces must also have a minimum reflectivity at the fundamental line in order to suppress that dominant transition.

The laser material may also be fabricated in a number of geometries. For example, it can be fabricated as a thin plate (a disc) or a long rod. Selection of the gain material geometry is generally dictated by considerations of pump absorption efficiency, available concentration, material properties, and heat removal requirements. Typically, a thin plate configuration is preferred from a thermal viewpoint, but there is often a trade-off with absorption length, and the optimal geometry may differ for different gain materials.

For microlaser structures, intra-cavity doubling is relatively simple to implement and is often more efficient than extra-cavity doubling arrangements. The prior art recognizes a number of techniques and approaches to fabricating compact, frequency converted miniaturized solid state lasers. For example, U.S. Pat. No. 6,111,900 teaches a method where a laser crystal and a nonlinear crystal are connected and combined by a spacer. SLM operation was realized through the concept of microchip lasers as taught by U.S. Pat. No. 4,860,304 to Mooradian and subsequent U.S. Pat. Nos. 4,953,166, 5,265,116, 5,365,539, and 5,402,437, which relied on selecting the cavity length to keep the gain bandwidth of the active medium always smaller than or equal to the frequency separation of the cavity modes.

Alternative techniques to construct a monolithic laser assembly including a laser medium and a nonlinear crystal include the method of “contact bonding” as used for example by one crystal manufacturer, VLOC Inc. (New Port Richey, Fla.). FIG. 2 represents the intra-cavity frequency doubled microlaser resonator configuration commercially offered by VLOC Inc. As shown, the assembly is pumped from the left by a diode beam at or near 808 nm and the green beam emerges from the right face of the nonlinear material. This configuration is often referred to as a flat-flat resonator, and in the sense understood by laser designers, is unstable. However, because all lasing elements exhibit thermal lensing or gain-guiding, effects in the crystals can be exploited to obtain stable operation. In this example, the laser consists of a monolithic crystal assembly including a Nd-doped laser crystal (typically Nd:YAG or Nd:YVO₄) optically contacted to a nonlinear frequency doubling crystal (typically KTP), with the assembly end surfaces coated to maximize the green output. To form the resonator, the left Nd:YVO₄ surface is coated to be HT around the diode pump wavelength at around 808 nm and HR at 1064 nm and 532 nm, while the right KTP surface is coated to be HR at 1064 nm and HT at 532 nm, and it serves as the outcoupler of green radiation. The internal contact-bonded surfaces are typically uncoated and there exists a small reflective loss due to the index of refraction difference between the Nd:YVO₄ and the KTP crystals. As is customary in the art of constructing a frequency doubled Nd:YVO₄ laser, the Nd:YVO₄c axis is rotated by 45° with respect to the KTP oriented for Type II phase matching direction defined by the crystalline angles θ=90° and typically φ=23°. When completed, the crystal assembly is quite compact, the KTP crystal having dimensions of 5 mm×5 mm×1.5 mm thick, and the Nd:YVO₄ having dimensions of 3 mm×3 mm×0.4 mm, according to the manufacturer's literature. Like the microlaser of Mooradian et al., the short cavity length means that this assembly is capable of operating in a SLM and/or STM over some limited power range. The laser can also be run STM by creating an appropriate diode-pumped excitation spot-size in the assembly. The method of contact bonding includes placing the elements to be bonded in close optical proximity, resulting in a strong Van der Waals attraction between the surfaces. The contact is typically sealed around the edges of the bond using a glue such as methylacrylate. With this type of monolithic laser assembly, the actual laser uses only a small fraction of the available crystals' volume. In typical green and infrared laser devices, for example, a section of only 100-200 μm of the central region of the crystal is used. The remaining portion of expensive crystal material is thus wasted, making it difficult to further minimize the material cost of each completed assembly.

Other alternate technologies for producing miniaturized lasers operating in the visible include frequency-doubled VCSEL (Vertical Cavity Surface Emitting Lasers) structures either externally or internally as described, for example, in recent U.S. Pat. Nos. 6,614,827 and 6,243,407.

The prior art recognizes a number of other attempts to construct compact diode pumped laser packages. Alternative approaches utilizing diode pumped solid state lasers with or without frequency conversion include packaging the laser medium in a TO semiconductor package as was described for example by Mori et al. in U.S. Pat. No. 5,872,803. The package described in this patent relies however on mechanical mounting techniques in a relatively bulky TO-3 semiconductor electronics package which is typically 1×1×1.5 inches long (including a TE cooler). Mechanical adjustments can, however, result in stresses to the optical components, compromising alignment and output stability properties, especially if nonlinear elements are to be included in the cavity.

U.S. Pat. No. 6,891,879 to Peterson et. al. uses a TO semiconductor package (TO-3). Peterson uses a large TO-3 package to construct diode-pumped solid-state lasers that are extra-cavity doubled. Peterson utilizes a TO-3 package in which the diode and the crystals and alignment features must be mounted.

There is a need in the art for methods for fabricating and producing low-cost, high-density (watts or milliwatts of output power divided by the device volume) micro laser devices, and in particular micro laser devices operating in the green spectral region near 532 nm. In particular, for the consumer market, there is a need for laser packages that can produce visible light at sufficient powers yet are small enough and have sufficiently low unit costs to be able to compete with semiconductor diode lasers. There is also still a need to be able to produce miniaturized lasers that can be adapted to operate at a variety of wavelengths in the UV through the infrared for applications such as biomedical instrumentation. For many applications, it is also important that manufacturing and operational costs remain low even for high end applications where reliable SLM and/or STM operation is required with low noise characteristics.

### SUMMARY OF THE INVENTION

A miniaturized laser package includes a modern laser diode package (LDP), modified to accept a solid state microchip assembly pumped by the diode laser. The microchip assembly is added to standard LDPs containing laser diodes mounted on heatsinking shelves by affixing a second shelf to mount and heatsink the microchip assembly. Standard packages described in the invention include 9 mm and 5.6 mm packages, all of which are characterized by small dimensions, well sealed housing, robust mounting features, known characterized materials, and economical production and assembly techniques characteristic of the laser diode industry. In particular, the microchip lasers are produced using techniques that lend themselves to mass production, resulting in very low unit costs. The compact laser devices provide laser radiation at high beam quality and good reliability with a variety of wavelengths and operational characteristics and low noise features not available in prior art diode lasers, while relying primarily on standardized designs, materials, and techniques common to diode laser manufacturing. The devices constructed according to methods taught by the present invention can therefore be readily integrated into numerous applications where power, reliability, and performance are at a premium but low cost is essential, eventually replacing diode lasers in many existing systems and also enabling many new commercial, biomedical, scientific, and military systems.

This invention addresses methods for producing high-density low-cost micro and miniature laser resonators with high beam quality laser radiation that can be assembled in highly compact packages using fabrication methodologies compatible with mass production and low unit costs (<$25). The present invention provides solutions to the challenge of designing for manufacturability using techniques characterized by their simplicity, cost effectiveness, and adaptability to operation at many different modes and a variety of wavelengths in either the visible or beyond. The invention further emphasizes those packaging technologies, laser designs, and materials that can provide high performance without compromising reliability of the microlaser devices, all at a material cost that can be as low as one to a few dollars. This makes the miniature devices of the present invention suitable to be integrated into numerous applications including the consumer and biomedical markets, potentially supplanting and replacing existing diode laser technology. The techniques disclosed also lend themselves to microlasers that can produce radiation at a large variety of operational modes and wavelengths. Specifically, the present invention provides improved methods, systems, and devices for providing cost effectively operational modes that include SLM in both CW and pulsed versions and spectral ranges that extend into the eye-safe region on one end and the UV region on the other end.

In one embodiment of the invention, a miniaturized diode pumped solid state laser is provided in a package adapted from a standard laser diode package by extending a shelf directly from the diode laser's mounting platform. A gain crystal assembly which includes at least one active laser material is affixed to the shelf following alignment and optimization of the output. The gain crystal assembly is generally disposed within a resonator including at least two mirrors wherein one or both mirrors may be directly deposited as a coating on the crystal assembly's faces.

The laser diode package dimensions may be selected to correspond to any standard laser diode package including the 9 mm and 5.6 mm packages. The type of package is generally determined by the diode power requirements.

The present invention adds solid-state laser crystals to modern laser diode packages that have the diode laser already incorporated. Using laser diode packages permits easily replacing red diode lasers with green lasers because the package diameter is the same and so are the electrical connections. Thus, green lasers manufactured using the present invention may be plugged into spaces and receptacles previously used for red diode lasers.

In another embodiment of the present invention, the package may include additional features and/or optical elements designed to produce different operational features from one standardized, mass producible package. These features include means for controlling the power, spatial beam quality, bandwidth, and wavelength of the output. For example, in one embodiment, the temperature of the diode as well as the gain crystal assembly may be independently controlled and adjusted using heat sinks and thermoelectric coolers (TECs). In another embodiment, the entire package may be mounted on an external cooler to provide improved performance at higher powers.

The present invention provides low-cost gain crystal assemblies with the largest output power density (mW/cm³) possible.

The present invention provides output powers of over 30 mW in the visible from packages such as the 5.6 mm that preferably have volumes of less than 1 cm³, which was not previously possible with available prior art techniques and fabrication methodologies. With specialized heat sinking of the gain crystal assembly, over 250 mW was demonstrated in the green from a modified 9 mm package, using monolithic resonators of Nd:YVO₄/KTP crystal composites with excellent beam quality and high stability features of the output.

In another embodiment, the present invention produces pulsed output from the microlasers. In one embodiment, laser beams from the UV to the infrared are produced with nanosecond pulse durations and high repetition rates as required for numerous applications in biotechnology, fiber laser seeding, and military technologies. The small size and low cost of the pulsed devices allow ready integration into systems, much in the same way as is currently done with semiconductor diode lasers.

In other embodiments, more advanced high end devices may incorporate feedback loops and sensors integrated in the package as is often done in semiconductor lasers—to provide additional ways to control the output. The ability to adapt and integrate known features and elements of semiconductor laser technology is a key advantage of the methods of the present invention, enabling maximum operational flexibility at the lowest unit prices from very compact packages.

A further understanding of the nature and advantages of the invention will become apparent by reference to the remaining portions of the specification and drawings.

### BRIEF DESCRIPTION OF THE DRAWINGS

FIG. 1 is a schematic of prior art intra-cavity frequency-doubling.

FIG. 2 illustrates a prior art bonded VLOC chip resonator.

FIG. 3 shows the configuration of a solid state microlaser mounted in a modified laser diode package.

FIG. 3A provides a view of the configuration and components of a prior art standard 9 mm diode laser package.

FIG. 4 is another embodiment of a microlaser modified laser diode package including a discrete outcoupler.

FIG. 5 is an embodiment of a gain crystal assembly with two cemented optical elements.

FIG. 6 illustrates a crystal gain assembly configured with a discrete curved outcoupler and suited for intra-cavity SHG.

FIG. 7 is an embodiment of crystal gain assembly with three optical elements suited for third or fourth harmonic generation.

FIG. 8 is an embodiment of a microchip laser resonator including a gain medium and a Q-switch suitable for producing pulsed radiation.

FIG. 9 shows a schematic of a gain crystal assembly that may be used to produce Q-switched frequency converted radiation from a modified diode laser package.

FIG. 10 is one embodiment of a gain crystal resonator assembly including a passively Q-switched eye-safe microlaser.

### DETAILED DESCRIPTION OF THE INVENTION

The present invention includes solid-state laser crystals incorporated into laser diode packages like the 5.6 mm and 9 mm, which already include a diode laser. In contrast, U.S. Pat. No. 6,891,879, to Peterson, uses a large TO-3 package to construct diode-pumped solid-state lasers that are extra-cavity doubled. In addition, unlike the present invention which relies on modern laser diode packages (LDPs), Peterson utilizes an older TO-3 package in which the diode and the crystals and alignment features must be mounted. The present invention is very different from Peterson, because green lasers of the present invention easily replace red diode lasers using modern laser diode packages, because the package diameter is the same and so are the electrical connections. Thus, unlike the devices in Peterson, the green lasers of the present invention may be plugged into spaces and receptacles previously used for red diode lasers.

The laser diode packages of the present invention are not equivalent to the standard semiconductor TO packages that were used in the prior art to package various semiconductor components like transistors. The old TO-3 package simply has a flat top on which various laser and optical components can be mounted. As another example, an older TO-18 package, the predecessor to the modern 9 mm LDP, does not include a shelf to mount a laser diode on. The vast majority of modern lower power laser diodes, for example, the TO-3 package manufactured by National Semiconductor (Santa Clara, Calif.) and the TO-1 8 manufactured by Schott (Duryea, Pa.), are mounted in 9 mm and 5.6 mm packages whose origin can be traced to the original TO-18 or TO-39 packages and TO-56 packages, respectively.

Modern laser diode packages (for example, those manufactured by High Power Devices Inc. (North Brunswick, N.J.) and Axcel, Inc. (Marlborough, Mass.)), however, bear little resemblance to these original semiconductor packages. The modern 9 mm and 5.6 mm laser diode packages have shelves for the laser diodes integrated into those packages. This is in contrast to the original TO packages where no such shelf exists.

The present invention specifically utilizes modern laser diode packages that are offered by numerous manufacturers worldwide, and that use modern versions of the older TO packages, in which the laser diode is already installed on a shelf that is an integral part of the package, to provide laser diode products to industry. While manufacturers such as High Power Devices offer diode products mounted on a shelf that is added to the older and much larger TO-3 package, that package is significantly larger than the laser diode package preferably used in the present invention because the diode pumped laser package of the present invention preferably occupies a volume less than or approximately equal to 1 cm³.

Many prior art techniques that are well known in the art of laser design may be beneficially and readily incorporated in the packaging techniques taught in the present invention. These designs include a variety of frequency conversion techniques such as harmonic generation, Raman conversion and optical parametric oscillation. The only limitation on use of these processes are the availability of nonlinear materials in sufficiently large sizes and good enough quality to allow them to be incorporated.

In order to construct miniature high-density low cost lasers, at least two key design aspects must be addressed. These are packaging and resonator design. The present invention incorporates unique features in each of these two areas that allow various combinations of materials and components to be configured to address a wide range of operational modalities, all sharing the common feature of compatibility with miniaturized, low cost, mass producible devices.

1. Packaging

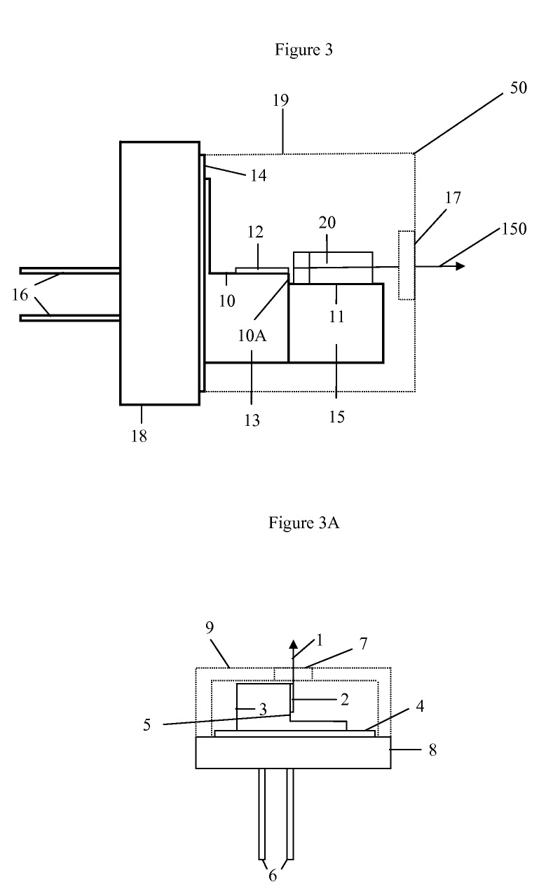

In order to package microchips into useful and mass-producible devices, it is important to have a package that will serve to minimize the overall laser volume while providing the functionality required for laser operation and the low costs associated with mass applications. In one preferred embodiment, a standard 9 mm laser diode package (LDP) is modified to accommodate a micro solid state laser as shown in FIG. 3. For illustrative purposes, the “9 mm package” is shown in inset 3A of FIG. 3, as this configuration is one of two LDP's known to set the standard for packaging commercial diode laser products used in the diode laser industry. The package generally includes pedestal 8 with a maximum outside diameter of 9 mm, typically fabricated using a Cu/W alloy, containing electrical leads 6. The two leads shown are isolated from the package body, typically by means of metal to glass seals. A third lead (not shown in the inset 3A) provides a ground for the body. A mounting platform or shelf 3 attached to the pedestal through a ridge 4 provides a surface 5 on which the diode 2 can be mounted. The ridge 4 generally provides a circular means for centering of the cover (or cap) 9 prior to securing it to the pedestal. In some packages, the platform 3 may include a suitable TEC cooler if active cooling of the diode is required. In most standard packages, the cover 9 is hermetically sealed in order to isolate the diode package from the environment, thereby protecting any sensitive interior structures. A transparent window 7 is embedded in the cover to allow transmission of the output beam 1 emitted by the diode 2. The window 7 is usually attached to the sealed cover 9 using standard metal to glass sealing techniques. Note that the older prior art TO packages contained no shelf on which to mount and heat sink the diode laser, while the modern LDPs all do.

In one preferred embodiment, the inventive configuration 50 of FIG. 3 is designed as a derivative of the standard LDP, including a similar circularly symmetric pedestal 18 connected to platform 13 through a ridge 14. The maximum outside diameter of the pedestal determines the type of the LDP, e.g., 9 mm for a “modified 9 mm package”, 5.6 mm for a modified “5.6 mm package” etc. The pedestal may be fabricated generally using the same Cu/W alloy used for the standard package with electrical power introduced through similar leads represented as 16. The platform 13 provides a surface 10 on which the diode 12 can be mounted, similar, again to the standard LDP of FIG. 3A. This mounting platform can be fabricated “in place” as part of the package fabrication process, eliminating the step of separately attaching the platform to the package, as would be required, for example, in a TO-3 package.

In one preferred embodiment of the package designed to accept the miniature or microchip lasers (alternately referred to as “microlaser”) of the present invention, the platform or mount 13 is extruded and another shelf 15 is created with a surface 11 on which to mount the micro laser assembly 20. The surfaces 10 and 11 on which the diode pump and microchip laser assembly are respectively mounted may be vertically offset from each other. This allows the diode 12 to be properly aligned at the edge 10A of the mounting surface 10, while pumping the center of the microchip laser crystal assembly 20. In the embodiment shown in FIG. 3 the diode-to-microchip energy transfer is achieved by way of a simple butt-coupling of the gain medium to the diode output facet. To obtain good laser efficiency with this scheme, it is important to minimize the air gap between the diode and the crystal assembly 20. Preferably the gap is less than about 1-2 μm thick. While this butt-coupling approach is the simplest, alternative coupling techniques using various lens combinations are also feasible as will be further described below.

In a second preferred embodiment, the shelf 15 on which the microchip laser crystal 20 is mounted is a separate element that may be bonded to the diode shelf/platform 13 or even to the ridge 14 by using an appropriate glue or solder.

In both embodiments, the microchip laser crystal assembly 20 preferably has dimensions of ˜1 mm×1 mm cross-section and is 2.5 mm long; the Nd:YVO₄ crystal includes ˜0.5 mm, and the KTP crystal ˜2.0 mm of the 2.5 mm length, and the Nd:YVO₄ crystal is mounted adjacent to the laser diode 12. The Nd:YVO₄ and KTP crystals are bonded together using glue, contact bonding, or diffusion-bonding. This type of microchip laser crystal assembly is commercially available from a number of sources worldwide and can be easily integrated into 9 mm and 5.6 mm LDPs.

As in the standard LDP, laser emission 150 takes place in a direction such that it passes through the custom output window 17 which is attached to a sealed cover 19 using metal to glass sealing techniques as are well known in the art of LDPs. The output window 17 may be fabricated from one of many optically transmissive materials, such as sapphire, fused silica, or glass, including optical glass that is absorptive at the fundamental wavelength at 1064 nm and transmissive at the doubled green wavelength of 532 nm.

Advantageously, the window may also be coated on one or both faces using AR coatings appropriate to the wavelength of the output beam 150 in order to reduce Fresnel reflection losses. The coatings on one or both surfaces may be designed to reflect 1064 nm light and transmit 532 nm light. The entire cap or cover 19 for the package is used to effectively seal the laser from the environment and may be welded to the pedestal 18 after diode and micro laser installation to provide a true hermetic seal. Alternatively, it may be glued or soldered down to provide a quasi-hermetic seal. The circular ridge 14 can be again used to define the center of the circularly symmetric cap 19 in a manner similar to well known procedures used in assembling standard LDPs, including the common 9 mm and 5.6 mm configurations.

In fabricating this laser package, an adhesive is preferably applied to the shelf 11 and the microchip crystal assembly 20, which may be wrapped in an appropriate protective heat sink, is then placed on top of the shelf. The cement assures that the complete microchip assembly is stably affixed to the mounting structure. The crystal assembly is then aligned to the pumping diode and any other optical elements in the package using appropriate precision alignment tooling. Once alignment is achieved, a UV lamp can be used to harden the cement and the microchip laser is then precisely and stably aligned. Alternatively, crystals may also be securely affixed to the shelf using standard soldering techniques. The length of the shelf 15 generally depends on the type of the microchip laser assembly and resonator design. Various derivatives of the general package of FIG. 3 with shelf lengths of anywhere between a few mm's to just over 20 mm could be constructed to readily accommodate any commercially available diodes with powers up to a maximum dictated by heat removal considerations, as will be further discussed below. In one example, with a basic monolithic configuration of the microchip assembly 20 including one or two elements, a resonator is defined solely by appropriate coatings placed on the two external faces of gain crystal assembly so that the output beam is produced without inserting any additional optical elements. In this example, the shelf 15 can be as short as 2-4 mm.

Generally, the 9 mm package has been found appropriate for running diodes up to 2 W output power, although special cooling methods may be required to efficiently remove the heat for diodes with powers in excess of 1 W. Most of the microlaser resonator embodiments described in the invention are compatible with pumping by diodes with power outputs of 1 W or less, allowing the 9 mm package to be utilized without any special cooling provisions. Of course, lower power diodes can be employed in scaled-down versions of the packaging concept of FIG. 3 to thereby meet the needs of applications requiring lower power devices. The 5.6 mm package is of particular interest, as it is another common industry standard. Although the smaller 5.6 mm diameter provides more limited thermal dissipation properties as compared with the larger sized packages, it may still be used effectively with diode output powers as high as 500 mW. Appropriately modified versions of this package can thus provide a suitable platform for low power versions of the micro lasers of the present invention. Both the 9 mm or 5.6 mm packages minimize the overall laser volume and the selection among them depends on the output power and laser mode desired. In preferred embodiments, the total volume of the microlaser package is less than about 1 cubic centimeter, considerably less than any of the prior art packages. It should however be understood that any other standard semiconductor packages or custom derivatives thereof also fall within the scope of the present invention. In particular, derivatives of the 5.6 mm and 9 mm LDPs and smaller LDPs incorporating a laser diode may alternatively be used.

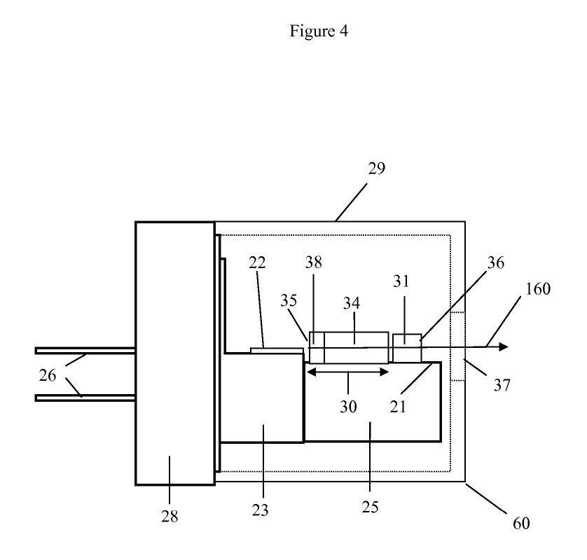

It is further recognized that, generally, in order to produce higher powers, a discrete outcoupler may need to be included in the package to facilitate alignment of components and allow stable and reliable operation at a range of power levels, up to the maximum specified power. Furthermore, it may be of particular interest to enable operation at a wavelength other than the fundamental excitation of the gain material. An example of an alternative embodiment suited to obtaining higher powers from a frequency converted diode pumped micro laser, is illustrated in FIG. 4. The configuration 60 represents a modification of the standard package of FIG. 3 including a diode pumped microchip crystal assembly but with an additional output coupler 31 defining the exit face 36 of the laser resonator. In this illustrative example, the microchip laser assembly 30 is shown with two elements: a gain laser element 38 and a nonlinear optical element 34 combined in a single monolithic assembly. The nonlinear optical element is typically selected to convert the frequency of the fundamental output produced by the gain medium 38 to some other desired output frequency. The back face 35 of gain element 38 facing the diode 22 is appropriately coated to provide high transmission of the diode pump wavelength and high reflection at the resonating and frequency converted wavelengths, serving as the back HR mirror for the laser resonator. The outcoupler 31 is then coated to transmit the frequency converted beam 160 to thereby provide maximum power at the converted wavelength. To eliminate any Fresnel losses, the window 37 embedded in the extended cover 29 may be AR coated for the same output wavelength. In some cases, such as when the nonlinear element 34 is a second harmonic generation crystal, one or both of the window surfaces may have a coating which is HR at the fundamental wavelength, thus further minimizing the fraction of light transmitted at any wavelength other than the desired one at the converted wavelength. In one preferred embodiment, the microlaser gain assembly includes a Nd doped gain crystal emitting at 1064 nm, such as Nd:YVO₄ or Nd:YAG, and the nonlinear element is a doubler crystal such as KTP or LBO. In this embodiment, the resonator defined by mirrors 35 and 36 is designed to emit green light at 532 nm and the coatings on all the surfaces are selected accordingly. A diode mounting shelf/platform 23, a pedestal 28, and leads 26, similar to the platform 13, pedestal 18, and leads 16 of FIG. 3, are also shown in FIG. 4. Any other known gain and nonlinear crystal combinations may however be selected, and the microlaser package 60 is therefore adaptable to produce a large variety of wavelengths, spanning the UV into the infrared spectral range, as discussed later in this disclosure.

In a typical configuration of FIG. 4, with the separate outcoupler 31 and the composite gain crystal assembly 30 including an active laser medium and a nonlinear element, the length of the shelf 25 may be further extended. This would give the configuration of FIG. 4 a typically longer package length. As for the transverse dimension, the 5.6 mm package diameter is still suitable for diode powers of up to 0.5 W, whereas a 9 mm package is more suitable for diode powers over 0.5 W—up to the maximum power permitted by heat removal considerations, as will be mentioned again below. In either case, the volume of the entire microlaser package is still on the order of or less than about 1 cm³.

Advantageously, in constructing the micro laser of the foregoing example, both the outcoupler 31 and the microchip assembly 30 including elements 34 and 38 are picked and placed on the extended shelf 25 using a precision alignment system. They can then be glued or soldered down to the surface 21 of the shelf using, for example, a UV curable optical cement (or indium solder) in a manner similar to that used for the basic configuration of FIG. 3.

One example of a modified 5.6 mm package uses a 0.2 W diode to pump a Nd:YVO₄/KTP composite according to methods of this disclosure, and an intra-cavity converted green laser packaged in a 6 mm long package using a simple flat-flat fully monolithic resonator configuration. This device, constructed according to FIG. 3, is capable of producing tens of mW's of single-transverse-mode green output power with good alignment and high reliability characteristics.

A discrete outcoupler may not be required even for diode powers of 1 W or so suitable for the modified 9 mm microlaser package as was shown in demonstrations producing in excess of 200 mW green output. Thus the configuration of FIG. 4 including an external outcoupler may be required only when diode pump powers exceed 1 W, at least for the standard frequency doubled CW Nd doped microchip laser.

Many variations of the basic package shown in FIGS. 3 and 4 are possible, and a few more are mentioned here. The diode used to pump the gain element of the microchip assembly may be either butt-coupled or direct-coupled, and the pump assembly may or may not include a short multimode fiber to symmetrize the astigmatic diode pump beam. The package may also be modified to house the microchip crystal assembly only, while the diode pump light is introduced through a fiber source. In addition, the diode may or may not include a fast-axis collimating (FAC) lens, a slow axis collimating lens, or both. Lensing of the diode is generally regarded as beneficial in equalizing divergence of the two dissimilar diode axes or else it may be used to collimate the diode output and reduce overall divergence, thereby increasing pump coupling efficiency to the gain medium. Pre-lensed diodes may be sometimes provided as part of commercial diode lasers or else such a lens or lens composite may be added between the exit face of the diode and the crystal gain module as another customized variation of the basic packages of FIGS. 3 or 4. As for the output characteristics of the diodes, these may be further selected from among commercially available semiconductor lasers, so that they may be adapted to pump a variety of media constructed from different gain and nonlinear material composites.

In different embodiments of the basic platform used to package the lasers, temperature control and/or stabilization of the miniature laser assemblies may be incorporated. For example, temperature control may be achieved by placing a thermistor or other miniature temperature sensing device and a TEC, either externally or internal to a 9 mm or 5.6 mm package. A miniature piezoelectric translator (PZT) may also be incorporated in the package to enforce a preferred laser output polarization or frequency tuning. In some applications where the laser output must be particularly noise-free, the entire package can be mounted on an external cooler such as a TEC to provide a constant operating temperature to the entire assembly. By temperature tuning the TEC to achieve SLM output, nearly noise-free lasers at the fundamental or harmonic wavelengths can be produced in this manner.

Alternatively, a cryogenic cooling system may be employed, by including, for example, cryogenic dewars, cold fingers, or closed cycle Gifford-McMahon or Stirling coolers as part of an overall package. For certain materials, such as, for example, Yb:YAG, which operates on a quasi-three-level fundamental transition at room temperature, more efficient four-level operation is achieved at low temperatures, and cryogenic cooling techniques may be especially beneficial. Generally, any of the temperature control techniques known in the art of cooling lasers, including, but not limited to the examples given above, may be incorporated with any of the aforementioned alternative packages (such as the 5.6 mm or 9 mm packages), all of which fall within the scope of the present invention.

To further aid in controlling the output of the laser, the package may also contain a photodiode for the purpose of providing feedback to an external electrical laser controller and/or controlling the temperature of the gain module, thereby providing constant power output with high amplitude stability over extended periods of time. Many such feedback techniques are known in the art of constructing stabilized diode pumped lasers, any of which may be incorporated in the packages discussed above.

Many of the optical, cooling, and electrical elements needed to design and operate microlasers at various functional modalities can be constructed using the preferred methods of assembly and packaging. In all cases, the modified LDP, used to house the microlaser, displays all the attributes desirable from devices that can be mass produced at low cost and offer the benefits of small size and weight without sacrificing performance or reliability. In particular, the platform selected builds on the high degree of mechanical integrity, compatibility with heat dissipation techniques, and built-in environmental shielding tools characteristic of well tested long-lived diode packages. Yet, the packaging is flexible enough to allow many design extensions to thereby meet the requirements of a wide variety of applications, all from a common low cost, mass producible device platform.

2. Resonator Design

Like mechanical packaging and gain module assembly and fabrication aspects, the resonator design for mass-producible micro lasers is inexorably tied to the overall cost of manufacturing the devices. In particular, the resonator design must be simple, yet capable of reliably producing the requisite performance with good optical stability, low noise, and acceptable lifetime characteristics. In some cases, the microlaser is expected to produce STM and SLM output. In other, less demanding cases the beam does not have to be STM but can be a lower-order mode while in still other cases, STM is required but not SLM.

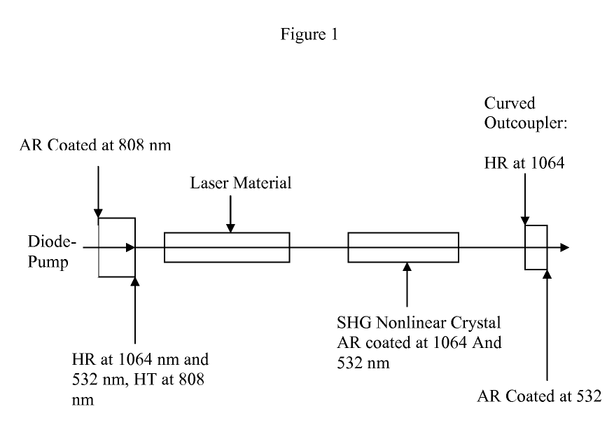

One resonator structure of particular interest concerns the intra-cavity frequency doubled cavity. Generally, the cavity design in this structure is modified from FIG. 1 to fit into the standard LDPs that are the subject of the present invention. The second harmonic (SH) or nonlinear crystal is advantageously placed between the lasing material and the outcoupler, which may include a coating placed on the SH material itself or a separate element. Examples of commonly used nonlinear materials are KTP, LBO, BBO, BiBO, KNbO₃, LiNbO₃ and periodically poled materials such as PPLN and PPKTP. The nonlinear crystal end faces may be AR coated at both the fundamental and at the second harmonic wavelengths, or one end may have no coatings when it is bonded to a second crystal such as Nd:YVO₄ and nearly index-matched. Use of appropriate coatings may be important for obtaining good second harmonic generation (SHG) efficiency by minimizing losses due to Fresnel reflections at the end faces of the nonlinear crystal at the fundamental wavelength. The nonlinear crystal orientation and crystal cut are selected to insure that phase-matching occurs between the fundamental and SH wavelengths, following standard procedures known in the art of optimizing frequency conversion efficiency. The nonlinear crystal may be cut for Type I or Type II phase-matching, or it may include a periodically-poled crystal such as PPLN or PPKTP. The gain material may include any commonly available solid state laser medium, including Nd, Yb, Er and Tm doped crystal hosts. Based on current state of the art, the simplest miniaturized lasers suitable for producing SH radiation in the visible are based on materials such as Nd:YAG and Nd:YVO₄. Nd:YVO₄ is especially attractive because of its high gain and absorption properties as well as ready manufacturability. In particular, excellent performance has been demonstrated using Nd:YVO₄ in conjunction with nonlinear materials such as KTP and LBO. In one example, a microchip gain assembly includes Nd:YVO₄ and KTP. It is understood however that many other gain and nonlinear material combinations fall within the scope of the present invention, provided they are commercially available in the requisite sizes.

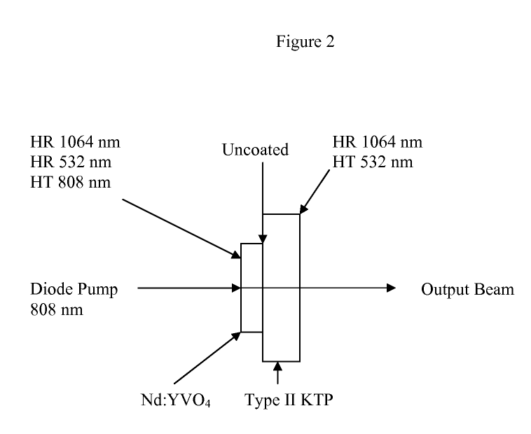

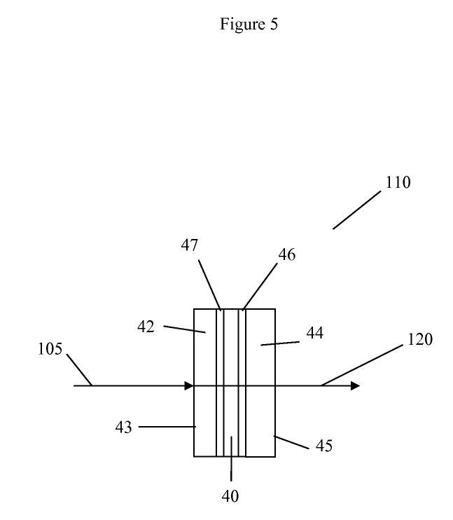

FIG. 5 shows an example of a crystal assembly 110 of the present invention. The assembly may include a gain material 42, and a nonlinear material 44; it is pumped using a laser diode 105. The nonlinear material may be cut to assure phase matching, for example, at the second harmonic of fundamental beam. In one preferred embodiment, using a Nd-doped gain material such as Nd:YVO₄ or Nd:YAG and a nonlinear crystal such as KTP or LBO, the output radiation 120 is in the green region, typically at 532 nm. In contrast with the prior art configuration of FIG. 2, rather than contact bonding the internal surfaces of the two media, they may be glued together using an appropriate optical glue material 40. Optical coatings 47 and 46 are applied to the glued surfaces of 42 and 44 to minimize reflective losses at those surfaces. Optical coatings 43 and 45 may also be applied to the outside surfaces (in contact with air) of 42 and 44 to further minimize optical losses. The Nd:YVO₄ crystal 42 surface facing the diode 105 has HT at 808 nm, and is HR at 1064 nm and 532 nm. The KTP exit surface through which the output beam 120 passes is HR at 1064 nm and HT at 532 nm.

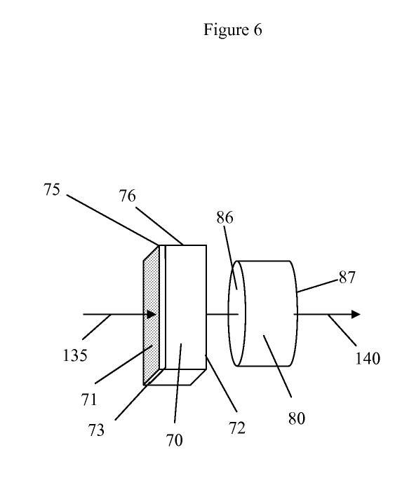

The simplest and easiest resonators to produce at low cost are flat/flat resonators because it is relatively straight forward to optically finish two surfaces to be parallel to one another and the crystal assemblies are therefore amenable to the fabrication cost savings associated with flat crystalline elements. It is, however, well known in the art of designing diode end-pumped lasers that some curvature may need to be introduced into the resonator to assure stable operation, especially at higher output powers. Thus, a flat/flat resonator design typically relies upon the induced thermal focusing or gain-guiding, or in some instances both to supply the requisite curvature. The all-planar cavity design is, however, power limited. For example, in the case of a bonded Nd:YVO₄/KTP crystal assembly glued to a shelf (see FIGS. 3 and 4), it was found through experimentation, that when the 532 nm output power exceeds a few tens of mWs, alignment of the crystal assembly becomes overly sensitive and difficult to maintain. However, if proper heat sinking is provided for the crystal assembly, for example by means of wrapping the assembly in heat conducting metallic foils, it was found that the all-planar cavity is capable of producing greater than 250 mW of green output power. It is noted here that similar resonator stability limitations also apply to commercially available contact-bonded crystal assemblies and are related to well known stability considerations for flat-flat resonators, irrespective of the type of bonding used. Thus, for higher powers (e.g., in excess of about 100 mW in the infrared and about 30 mW in the green without applying special heat sinking means) an alternative resonator design using, preferably, a flat/curved mirror configuration (the standard hemispherical resonator design, for example) is sufficient to enforce stability and thereby maintain alignment. Accordingly, an example of a preferred embodiment of a microlaser design using a flat/curved resonator is shown in FIG. 6. This example depicts an intra-cavity frequency doubled laser using a crystal assembly 70 including a gain medium 75 and a frequency doubling crystal 76 bonded together and producing an output beam 140 at the SH wavelengths. In a manner generally similar to that shown previously for FIG. 5, the microchip assembly is constructed with the interface 73 between the gain material 75 (such as Nd:YVO₄) and the nonlinear crystal plate 76 (made of e.g., KTP) filled by a layer of optical cement (not shown in FIG. 6) and the faces in contact with the cement layer are preferably dielectrically coated with suitable AR coatings to eliminate reflective losses. A coating that is high reflecting (HR) at the fundamental and SH wavelengths but is transparent to the wavelength of diode pump beam 135 is applied to the flat surface 71 of assembly 70, similar again to the embodiment of FIG. 5. However, a discrete curved outcoupler 80, coated to extract the second harmonic radiation, is now added to form the cavity. The output face 72 of the nonlinear material is then AR coated at both the fundamental and SH wavelengths (instead of the HR coating shown previously in FIG. 5). Preferably, the outcoupler element 80 is placed close to or in contact with the nonlinear crystal output face 72 to maintain the small dimensions of the laser. The outcoupler may have a finite curvature on its left surface 86 (facing the nonlinear element), and is preferably coated so it is HR at 1064 nm and HT at 532 nm. The particular magnitude of the curvature is chosen to provide stability to the resonator, following standard optical design methods know in the art. The output surface 87 of the outcoupler 80 may be coated to be AR at the SH, following the standard procedure for an intra-cavity doubled laser. A flat/curved cavity design for a microchip assembly includes a YVO₄ gain material and a KTP doubler. This design provides stability and maintains STM output for 532 nm output powers well above 250 mW, allowing the microchip resonator to produce scaled-up green output power levels with good beam-quality. Furthermore, while the flat/curved embodiment may be somewhat more expensive than the flat/flat microchips previously discussed due to added materials and fabrication costs, it maintains the advantages of compactness, and easy alignment compared to prior art techniques.

It is also noted that in a variation of the flat/curved embodiment of FIG. 6, the curvature may be put on the output or the right face 87 of the outcoupler 80, leaving the left inside surface, 86 flat. Such a configuration would allow the outcoupler 80 to be directly glued to the SH crystal AR coated surface 72 forming a three plate sandwich structure, using, e.g., the same optical cement employed in the previously discussed examples. The inner surface 86 of the outcoupler would then be preferably dielectric coated to minimize reflective losses, whereas the outer curved surface 87 may be coated for HR and HT at the fundamental and SH wavelengths, respectively.

There are many other variations on the basic intra-cavity doubled resonator of FIG. 6, as most of the possible prior art approaches applicable to bulk lasers of the kind shown in FIG. 1 can be implemented in a miniaturized form using the packaging and high density production techniques that are the subject of the present invention. As one example, the backward traveling green light in the resonator may be collected by placing HR coating appropriate to the SH wavelength on the left surface 73 of the nonlinear crystal 72 instead of the AR coating described earlier. This avoids having to pass the SH beam through the laser crystal 75, though at a cost of some added complexity to the cavity design and more stringent requirements on the adhesive used to affix the gain crystal to the nonlinear material. In still another embodiment, more than one wavelength may be provided simultaneously from a single micro resonator. For example, using appropriate coatings, a crystal assembly such as that shown in FIG. 5 can be designed that will simultaneously produce output at 1064 nm and 532 nm. These and other variations on the basic intra-cavity frequency converted design of FIG. 1 that are known to one skilled in the art all fall within the scope of the present invention.

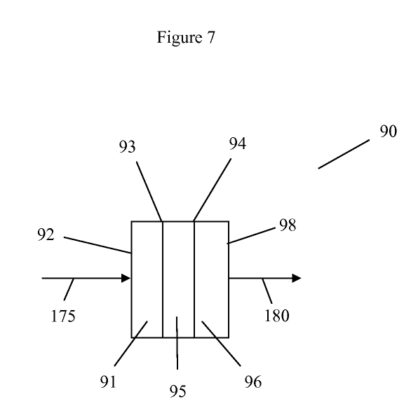

Additional nonlinear crystals may also be inserted into the cavity in order to convert the second fundamental wavelength into higher harmonics, for example, in the UV, in which case the microchip assembly components and the associated coatings have to be modified appropriately. Particularly, fabrication of gain assemblies using the techniques of gluing and processing larger wafers followed by dicing into miniaturized assemblies can be extended to crystal assemblies with multiple rather than just the two wafers shown earlier. FIG. 7 shows an embodiment of a crystal assembly design that can be used to produce third or fourth harmonic light from a fundamental transition such as the 1064 nm transition in Nd:YAG or Nd:YVO₄. The assembly 90 in this embodiment may include a gain material 91, a first nonlinear material 95 and a second nonlinear material 96. The first nonlinear material is typically a crystal cut for SHG and the second nonlinear material may be cut for third harmonic or fourth harmonic generation. In one example, the gain material is Nd:YVO₄, the SH crystal is KTP and the second nonlinear crystal may be LBO or BBO. The cut of the crystals and the coatings determine whether third harmonic at 355 nm or fourth harmonic at 266 nm are generated. The left outer surface 92 of the assembly is typically coated to be HR at the fundamental and SH wavelengths and HT at the pump wavelength so as to allow pump radiation 175 to excite the active ions in gain medium 91. The coating on the outside right face 98 of the assembly is preferably selected to be HR at the fundamental and HT at the wavelength of output beam 180. Since the surface 98 of the second nonlinear crystal serves as an output coupler, it may be polished flat or curved, depending on conditions required to maintain cavity stability for given level of circulating power. The resonator is then formed between this outcoupler surface and the HR coated left surface 92 of the gain material 91. For third harmonic generation (THG), the coating on the outside right surface 98 may be further selected to provide high reflection also at the second harmonic so as to allow another pass through the third harmonic crystal 96, which then combines again with the resonating fundamental in a sum frequency mixing (SFM) process thereby doubling the overall UV output. For fourth harmonic generation (FHG) on the other hand, the surface 98 may instead be coated for either HT or HR at the SH wavelength, depending on the required power and propensity to damage of the optical components at the fourth harmonic wavelength. The interface 93 between the gain material and the first nonlinear crystal and interface 94 between the two nonlinear crystals are each cemented using appropriate optical glue as was described in connection with FIG. 5. The interface 93 is preferably formed between each of the two cemented surfaces AR coated at both the fundamental and the SH wavelengths as was also described earlier. Interface 94 includes two similarly AR coated surfaces for the fundamental and SH that are adhered together using an appropriate optical cement. To prevent any residual third or fourth harmonic beam from traveling back through the SH crystal 95 and the gain material 91, another coating layer on the inside surface of second nonlinear crystal 96 may be deposited so that it is HR in the UV—with peak reflection at either the third or fourth harmonic wavelength, depending on the desired output.

Still other crystal assemblies may be fabricated to provide multiple wavelengths using Stokes shifting in solid-state Raman converters such as calcium tungstate (CaWO₄). A simple example constructs a microchip assembly by gluing or bonding a solid-state Raman material to a Nd-doped crystal, with the facing surfaces deposited with appropriate dielectric coatings. Raman shifted output from a Nd-doped crystal such as Nd:YVO₄ emitting at 1064 nm include discrete Stokes shifted lines between 1.15 out to longer than 1.5 micron. In the case of calcium tungstate, the first shifted Stokes line is at about 1.18 μm. This line can be frequency doubled (externally or internally) to give radiation in the yellow near 589 nm, corresponding to the important sodium line.

The inventive techniques used to produce micro lasers as described so far may also be adapted to provide resonator configurations operating on any number of alternative laser transitions, depending on the application needs. Table 1 lists some of the transitions utilized in commonly used Nd-doped laser materials. Clearly the SHG, THG, and FHG processes described above can be applied to any laser transition as long as a suitable nonlinear crystal can be identified that will phase match to provide the requisite harmonic output. Alternatively, embodiments where two laser transitions are combined intra-cavity using a nonlinear crystal cut to phase match for SFM, thereby further increasing the range of wavelengths that may be produced with the high density microchip fabrication and miniature laser packaging principles described in the disclosure. In one particular example, not shown explicitly in Table 1, one could, for example, use SFG of the 1318.7 nm and 946 nm transitions in Nd:YAG to produce yellow laser radiation at 550.84 nm. This spectral range may be especially useful for biomedical and bioinstrumentation applications.

TABLE 1
Fundamental and Second Harmonic Wavelengths
for Various Laser Crystals
Laser Transitions Assumed Operating Near 300K

| | Fundamental | |
|---|---|---|
| Material/Transition | Wavelength (nm) | SHG Wavelength (nm) |
| Nd: YAG | | |
| ⁴F_{3/2}—⁴I_{13/2} | 1318.70 | 659.35 |
| ⁴F_{3/2}—⁴I_{11/2} | 1064.20 | 532.10 |
| ⁴F_{3/2}—⁴I_{9/2} | 946.00 | 473.00 |
| Nd: YVO₄ | | |
| ⁴F_{3/2}—⁴I_{13/2} | 1341.92 | 670.96 |
| ⁴F_{3/2}—⁴I_{11/2} | 1064.28 | 532.14 |
| ⁴F_{3/2}—⁴I_{9/2} | 915.25 | 457.63 |
| Nd: YALO | | |
| ⁴F_{3/2}—⁴I_{13/2} | 1341.40 | 670.70 |
| ⁴F_{3/2}—⁴I_{11/2} | 1079.50 | 539.75 |
| ⁴F_{3/2}—⁴I_{9/2} | 870.00 | 435.00 |
| Nd: YLF | | |
| ⁴F_{3/2}—⁴I_{13/2} | 1313.00 | 656.50 |
| ⁴F_{3/2}—⁴I_{11/2} | 1053.00 | 526.50 |
| ⁴F_{3/2}—⁴I_{11/2} | 1047.00 | 523.50 |
| ⁴F_{3/2}—⁴I_{9/2} | 908.27 | 454.13 |
| ⁴F_{3/2}—⁴I_{9/2} | 903.50 | 451.75 |
| Yb: YAG | | |
| ²F_{5/2}—²I_{7/2} | 1029.30 | 514.65 |

Many other potential active ions and laser host combinations not shown in Table 1 may be amenable to the microchip resonator fabrication and packaging techniques. Such combinations may include alternative rare earth ions such as Er, Tm and Yb doped into host crystals that include garnets, such as YAG, vanadates and fluorides such as YLF. Essentially any ion/host crystal combination may be utilized, as long as the crystals are manufacturable in sufficient size and good enough quality to be amenable to the high density fabrication processes of interest here.

Solid state lasers may be operated in many temporal formats, including continuous-wave (CW), Q Switched (QS), Long-Pulse (LP), and Mode-Locked (ML). Whereas most examples shown thus far, including the intra-cavity frequency converted laser 15 embodiment and the associated microchip assemblies of FIGS. 5 to 7, operate in a CW mode, the general principles of the invention are also valid for the corresponding pulsed cases. In analogy with methods well known in the art, a variety of means can be used to change the temporal format of the output from the CW format.

In the simplest approach, the laser diode source can, for example, be modulated, that is, be turned on and off at some desired rate to produce laser output that is rising and falling in a manner generally proportional to the laser diode power. For 100% laser diode modulation, turning the laser diode pump off and on at a prescribed repetition rate produces long-pulse or free-running output at the same repetition rate. As frequency conversion efficiencies are not expected to be markedly affected in this case, the harmonic output produced in any of the intra-cavity configurations described above are therefore modulated but with the overall average power output the same as that obtained for the corresponding CW case.

In another class of alternative embodiments, a Q-switch, preferably either an active modulator or a passive saturable absorber, may be inserted in the cavity to provide Q-switched (QS) operation with pulse durations in the nanosecond range or even below, depending on the laser material, repetition rate and overall cavity length. In particular, there are prior art teachings that demonstrate the viability of adding a Q-switch to the basic intra-cavity doubled resonator of FIG. 1 to provide short pulse operation in the few nanoseconds or even the sub-nanosecond range. The Q-switch may be an active modulator, such as an acousto-optic (AO) or electro-optic (EO) Q-Switch or it may include a passive Q-switch, such as Cr⁴⁺:YAG. Examples of prior art techniques using Q-switching in a microlaser include, among others, U.S. Pat. No. 5,703,890, where an active Q-switching technique was described, and U.S. Pat. Nos. 6,023,479 and 5,488,619, where passive QS microcavities were taught using passive Q-switching and/or mode locking means. These and other similar techniques amenable to the packaging and high density fabrication techniques that are the subject of the present invention are all incorporated by reference herein. Some examples of Q-switched gain crystal assemblies that may be constructed and packaged with the techniques of the invention are described next.

In general, whereas CW intra-cavity conversion efficiencies can exceed 30% for simple laser designs, conversion efficiencies exhibited by pulsed lasers may exceed 50% due to higher intra-cavity intensities. Consequently, the intra-cavity converted output from a QS laser embodiment may have average power that is higher than the corresponding CW embodiment, for the same input pump power. In addition, the higher peak powers attainable through use of a QS allow the laser to address the needs of the large number of applications where short pulse durations are a prerequisite. It is therefore of interest to construct pulsed versions of the miniaturized resonators discussed earlier using high density techniques and compact, low cost packaging approaches disclosed herein.

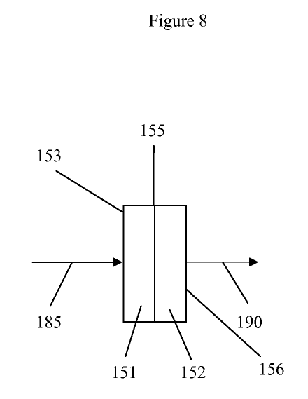

In FIG. 8, crystals and Q switches may be selected to provide Q-switched pulsed output at various wavelengths. In one embodiment 151 is Nd:YVO₄ or Nd:YAG and 152 is a passive QS such as Cr⁴⁺:YAG. The two crystals may be bonded together at an interface 155 using glue, diffusion bonding, contact bonding, or any other suitable method. The assembly is pumped with a CW or quasi-CW laser diode 185 and pulsed output 190 results. The surface 153 is HT at 808 nm and HR at the fundamental laser wavelength of 1064 nm. The outcoupling surface 156 is partially reflective at the fundamental laser wavelength. An alternative version includes an assembly designed for eye-safe operation with a gain material made of Yb,Er:Glass, operating at 1540 nm and a passive Q-switch made of CO²⁺: Spinel or some other material appropriate to this wavelength. In this case, the Yb absorption band is pumped by a diode operating near 940 nm followed by energy transfer to the Er ion which lases at 1540 nm. Because the crystal thicknesses can be minimized in this case, this type of a pulsed eye-safe micro-laser is highly amenable to mass production.

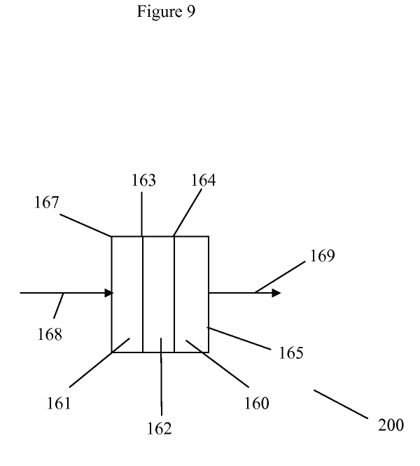

The methods of producing QS operation may be extended to utilize more complicated microchips operating at other wavelengths and alternative operating modes, as long as appropriately optimized resonator constructions are implemented to realize desired operation. In one embodiment of a frequency converted Q-Switched laser resonator providing pulsed SH radiation, the gain/saturable absorber microchip assembly of FIG. 8 is extended to a three plate composite 200 as shown in FIG. 9. Here, the gain crystal 161 is bonded to a saturable absorber Q-switch 162 which is then bonded to a nonlinear crystal 160 such as KTP or LBO. The coatings on the left side 167 are selected to allow high reflection of the fundamental and the harmonic and high transmission of the diode pump radiation 168. The coatings on the right surface of the assembly 165 may be selected to optimize the power of the harmonic radiation 169. The interfaces 163 and 164 between the gain material and the Q-switch, and the Q-switch and the nonlinear crystal include the cemented surfaces of the optical elements, which may be AR-coated. The surfaces including interfaces 163 and 164 may also be deposited with multi-layer coatings, the design of which may be unique to each assembly and resonator design. For an intra-cavity frequency doubling embodiment, the surfaces may be dielectrically coated for AR for both the fundamental and the SH. In this case, the right hand side 165 of the assembly, which may be flat or curved, is advantageously coated for HR at the fundamental and HT at the SH, in a manner similar to the CW gain module of FIG. 5. Alternatively, in such a Q-switched resonator, extra-cavity frequency conversion is also feasible with high efficiency and may be preferred in certain instances. An extra-cavity arrangement may be implemented through the simple means of choosing different coatings on the different surfaces. For example, the interface 164 may be coated for PR at the fundamental and HR at the SH, while the output surface 165 is coated for AR at the SH as for the intra-cavity case. Numerous other options are feasible with this basic design, depending on the required power levels, availability of coatings, and desired wavelengths. At higher power levels, considerations of damage to both coatings and bonding material may dictate preferred resonator design.

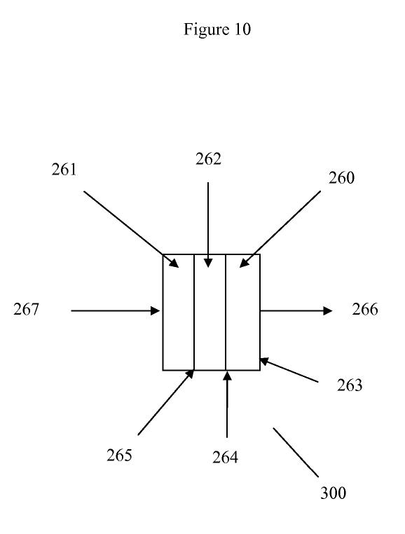

There are several alternative embodiments of the basic QS assembly of FIG. 9. In one embodiment shown in FIG. 10, an eye-safe laser operating near 1540 nm may be produced using an optical parametric oscillator (OPO) device consisting of appropriately coated KTP or KTA crystal for the nonlinear element 165 of FIG. 9. In this embodiment, the three layer microchip laser assembly may include a Nd:YVO₄ gain crystal 261 bonded to a Cr⁴⁺:YAG Q-switch 262, which is, in turn, bonded to a KTP or KTA nonlinear crystal 260 phase-matched to the 1064 nm fundamental transition in Nd:YVO⁴. The right face 263 corresponding to the surface 165 in FIG. 9 of the KTP/KTA crystal may be curved to provide resonator stability and allow operation in STM and is coated for HR at 1064 nm and PR at 1540 nm. The interface 264 for this embodiment would be preferably coated for HR at 1540 nm and AR at 1064 nm, following standard design for an OPO. The other interface 265 has both surfaces coated simply for AR at the fundamental or has both surfaces uncoated. The output 266 includes the desired 1540 nm output which is pulsed at repetition rates on the order of 10's of kHz. The crystal assembly is pumped with a diode laser 267. Expected pulse durations of this microchip laser assembly are in the range of a few nanoseconds.

It is noted that this type of a laser microchip tends to be significantly longer than the devices shown previously because the nonlinear coefficient for 1.54 μm generation is small and as much as 1-2 cm of the OPO crystal length may be required to produce good efficiency. Still, existing LDPs may be modified or custom re-designed to realize this eye-safe laser. For higher power versions of the pulsed micro-lasers, thin plates of electro-optically active material such as lithium tantalate may be used to actively Q-switch the resonator. In particular, a Q-switch element may be inserted in the higher power resonator version of FIG. 6 to allow power scaling of the fundamental or SH output. Miniature low-cost pulsed resonators can therefore be built even for high peak powers using techniques disclosed herein. All such extensions of the basic resonator designs fall within the scope of the present invention, provided they are amenable to the high density fabrication techniques and low cost mass producible packages that are of interest here.

As has been described in the foregoing, there are a large number of specific implementations of the microchip laser technology of the present invention that are capable of low cost mass-production. While specific examples have been provided, it should be apparent to those skilled in the art that many more modifications and variations of the basic invention are possible and that the use of a different resonator, operating mode, laser materials, Q-switches or method of Q-switching, nonlinear crystals, coatings or combinations of coatings is still within the spirit of the invention as described herein. Thus, the foregoing descriptions of preferred and alternate embodiments of the invention have been presented for purposes of illustration and description and are not intended to be exhaustive or limit the invention to the precise forms disclosed. It is intended that the scope of the invention be defined by the following claims and their equivalents.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A miniaturized solid state laser package comprising:
a gain crystal assembly, comprising at least one active laser medium, pumped by a diode laser having a pumping wavelength, wherein the laser medium emits radiation at a lasing wavelength;
a resonator cavity comprising a first mirror and a second mirror opposing the first mirror, wherein the first mirror comprises a coating configured for high reflection at the lasing wavelength and high transmission at the pumping wavelength and placed directly on a surface of the gain crystal assembly proximate to the diode laser, and the second mirror comprises an outcoupler defining an exit face of the resonator, wherein the gain crystal assembly is disposed within the resonator cavity; and
a shelf comprising an extension of or an attachment to a mounting platform supporting the diode laser in a standard laser diode package, wherein the resonator cavity is mounted on the shelf.

2. The solid state laser package of claim 1 wherein the laser diode package is selected from the group consisting of a 5.6 mm laser diode package and a 9 mm laser diode package.

3. The solid state laser package of claim 1 further comprising a feedback control loop for stabilizing power output of the resonator, wherein the feedback control loop includes a photodiode for sensing power output.

4. The solid state laser package of claim 1 where the gain crystal assembly is enclosed in a heat sink.

5. The solid state laser package of claim 1 further including means for stabilizing an output wavelength of the diode laser.

6. The solid state laser package of claim 1, further comprising an external cooler on which the laser diode package is mounted.

7. The solid state laser package of claim 1 wherein the gain crystal assembly comprises a composite of a first material and a second material, wherein the first material comprises the active laser medium.

8. The solid state laser package of claim 7 wherein the second material is a nonlinear medium.

9. The solid state laser package of claim 8 wherein the nonlinear medium is configured for generating a second harmonic of laser radiation.

10. The solid state laser package of claim 8 wherein the nonlinear medium is configured and coated for parametric generation of radiation.

11. The solid state laser package of claim 8 wherein the nonlinear medium is selected from the group consisting of KTP, LBO, and KNbO₃.

12. The solid state laser package of claim 1 wherein the active laser medium comprises a rare earth element doped in a host.

13. The solid state laser package of claim 12 wherein the rare earth element is Nd.

14. The solid state laser package of claim 1 wherein the crystal gain assembly comprises a Nd:YVO₄ gain crystal and a KTP nonlinear material.

15. The solid state laser package of claim 1 wherein the gain crystal assembly comprises a composite of the active laser medium, a first nonlinear crystal, and a second nonlinear crystal.

16. The solid state laser package of claim 15 wherein the first nonlinear crystal is configured for second harmonic generation and the second nonlinear crystal is configured for generating a third or fourth harmonic of laser radiation.

17. The solid state laser package of claim 1 wherein the gain crystal assembly comprises two active laser mediums.

18. The solid state laser package of claim 1 wherein the resonator cavity is affixed to the shelf using glue.

19. The solid state laser package of claim 1 wherein the resonator cavity is affixed to the shelf using solder.

20. The solid state laser package of claim 1 wherein the outcoupler mirror is deposited directly on a surface of the gain crystal assembly distal to the pump laser diode.

21. The solid state laser package of claim 1 wherein the outcoupler mirror comprises a discrete optical element spaced apart from the gain crystal assembly.

22. The solid state laser package of claim 21 wherein the outcoupler mirror has a curved surface.

23. The solid state laser package of claim 1 wherein the resonator cavity has a flat-flat stable configuration.

24. The solid state laser package of claim 1 wherein the resonator cavity further comprises a Q-switch adapted to provide pulsed radiation.

25. The solid state laser package of claim 24 wherein the Q-switch comprises a saturable absorber.

26. The solid state laser package of claim 24 wherein the Q-switch comprises an active modulator.

27. The solid state laser package of claim 1 wherein the gain crystal assembly comprises at least two elements.

28. The solid state laser package of claim 27 wherein the two elements of the gain crystal assembly comprise dielectrically coated plates.

29. The solid state laser package of claim 27 wherein the elements of the gain crystal assembly are bonded together using optical glue.

30. The solid state laser package of claim 27 wherein the elements of the gain crystal assembly are bonded together using optical contacting.

31. The solid state laser package of claim 27 wherein the elements of the crystal gain assembly are bonded together using diffusion bonding.

32. The solid state laser package of claim 27 wherein the elements of the gain crystal assembly are joined using methods that reduce losses due to Fresnel reflections to less than 1% per pass.

33. The solid state laser package of claim 1 wherein the power output from the diode laser is at least 25 mW.

34. The solid state laser package of claim 1 wherein the green power output is at least 1 mW.

35. The solid state laser package of claim 1 wherein the resonator cavity provides output in a single longitudinal mode.

36. The solid state laser package of claim 1 wherein the resonator cavity provides output in a single transverse mode.

37. The solid state laser package of claim 1 wherein a volume of the entire package is less than 1 cm³.

38. A miniaturized solid state laser package comprising:
a gain crystal assembly, comprising at least one active laser medium, pumped by a diode laser, having a pumping wavelength, whereupon the laser medium emits radiation at a lasing wavelength;
a resonator cavity comprising a first mirror and a second mirror opposing the first mirror, wherein the first mirror comprises a coating configured for high reflection at the lasing wavelength and high transmission at the pumping wavelength and placed directly on a surface of the gain crystal assembly proximate to the diode laser, and the second mirror comprises an outcoupler defining an exit face of the resonator, wherein the gain crystal assembly is disposed within the resonator cavity; and
wherein the solid state laser package has a volume that is less than about 1 cm³.

39. The solid state laser package of claim 38 wherein the package is a laser diode package adapted and configured to hold the gain crystal assembly.

40. The solid state laser package of claim 38, further comprising a thermoelectric cooler that controls and adjusts a temperature of the gain crystal assembly.

41. The solid state laser package of claim 38, further comprising a heat sink, wherein the gain crystal assembly is enclosed in the heat sink.

42. The solid state laser package of claim 38 wherein the gain crystal assembly comprises a composite of a first material and a second material, wherein the first material comprises the active laser medium.

43. The solid state laser package of claim 42 wherein the second material is a nonlinear medium.

44. The solid state laser package of claim 43 wherein the nonlinear medium is configured for generating a second harmonic of laser radiation.

45. The solid state laser package of claim 43 wherein the nonlinear medium is selected from the group consisting of KTP, LBO, and KNbO₃.

46. The solid state laser package of claim 38 wherein the active laser medium comprises a Nd doped laser host.

47. The solid state laser package of claim 38 wherein the crystal gain assembly comprises a Nd:YVO₄ gain crystal and a KTP nonlinear material.

48. The solid state laser package of claim 38 wherein the gain crystal assembly comprises the active laser medium, a first nonlinear crystal and a second nonlinear crystal.

49. The solid state laser package of claim 38 wherein the gain crystal assembly comprises two active laser materials.

50. The solid state laser package of claim 38 wherein the outcoupler mirror is deposited directly on a surface of the gain crystal assembly distal to the pump laser diode.

51. The solid state laser package of claim 38 wherein the outcoupler mirror comprises a discrete optical element spaced apart from and in alignment with the gain crystal assembly.

52. The solid state laser package of claim 51 wherein the outcoupler has a curved surface.

53. The solid state laser package of claim 38 wherein the resonator cavity has a flat-flat stable configuration.

54. The solid state laser package of claim 38 wherein the resonator cavity further comprises a Q-switch adapted to provide pulsed radiation.

55. The solid state laser package of claim 54 wherein the Q-switch comprises a saturable absorber.

56. The solid state laser package of claim 54 wherein the Q-switch comprises an active modulator.

57. The solid state laser package of claim 38 wherein the gain crystal assembly comprises at least two elements.

58. The solid state laser package of claim 57 wherein the elements of the gain crystal assembly are joined using low loss methods that reduce losses due to Fresnel reflections to less than 1% per pass.

59. The solid state laser package of claim 38 wherein the power output from the laser diode is at least 25 mW.

60. The solid state laser package of claim 38 wherein the power output is at least 1 mW.

61. The solid state laser package of claim 38 wherein the power output is at least 1 mW of visible light.

62. The solid state laser package of claim 38 wherein the resonator cavity provides output in a single longitudinal mode.

63. The solid state laser package of claim 38 wherein the resonator cavity provides output in a single transverse mode.

64. A method of packaging a solid state micro-laser within a modified laser diode package, comprising the steps of:
removing a cap sealing the laser diode package;
extruding or attaching a shelf from a mounting platform supporting a semiconductor laser;
mounting a miniature gain crystal resonator assembly comprising at least one gain element and two mirrors onto the shelf,
aligning the semiconductor laser so it stably pumps the gain crystal resonator assembly;
bonding the gain crystal resonator assembly onto the shelf,
fabricating a modified cap containing an output window transparent to output radiation from the gain crystal resonator assembly, wherein a cap length is selected to accommodate a combined length of the mounting platform and the extruded shelf supporting the gain crystal resonator assembly; and
replacing the modified cap to seal the package.

65. The method of claim 64 wherein the laser diode package is a 5.6 mm package or a 9 mm package.

66. The method of claim 64 further comprising the step of cooling the gain crystal assembly with a thermoelectric cooler.

67. The method of claim 64 wherein bonding the gain crystal resonator assembly to the shelf is performed using a glue.

68. The method of claim 64 wherein bonding the gain crystal resonator assembly to the shelf includes the substep of soldering.

69. The method of claim 64 wherein the output window is anti-reflective coated at an output wavelength.

70. The method of claim 64 wherein a length of the gain element is selected to maximally absorb the semiconductor laser radiation.

71. The method of claim 64 wherein the solid state micro-laser package created by the method has a volume smaller than about 1 cubic centimeter.

72. The method of claim 64, further comprising the step of stabilizing power output of the miniature gain crystal resonator assembly.

73. The method of claim 64, wherein the step of stabilizing power output comprises the substeps of controlling and adjusting a temperature of the gain crystal resonator assembly.

74. The method of claim 64, further comprising the step of stabilizing an output wavelength of the semiconductor laser.
